(19) United States
(12) Patent Application Publication
(10) Pub. No.: US 2025/0349301 A1
(43) Pub. Date: Nov. 13, 2025

(54) AUTOMATIC SIGNAL PROJECTION FOR MULTICHANNEL DIALOGUE SEPARATION

(71) Applicant: Fraunhofer-Gesellschaft zur Förderung der angewandten Forschung e.V., Muenchen (DE)

(72) Inventors: Mhd Modar HALIMEH, Erlangen (DE); Emanuel HABETS, Erlangen (DE); Matteo TORCOLI, Erlangen (DE)

(73) Assignee: Fraunhofer-Gesellschaft zur Förderung der angewandten Forschung e.V., Muenchen (DE)

(21) Appl. No.: 19/206,033

(22) Filed: May 12, 2025

(30) Foreign Application Priority Data
May 13, 2024 (EP) 24175540.4

(51) Int. Cl. G10L 19/008; G10L 25/30

(52) U.S. Cl. CPC G10L 19/008; G10L 25/30

(57) ABSTRACT

There is disclosed, inter alia, a system for deriving, from an input multi-channel audio signal, a multi-channel target signal in compressed form, the system comprising:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels; and
an output unit to output the multi-channel target signal in compressed form as the single-channel target signal and the array of multi-channel projection coefficients.

### CROSS-REFERENCE TO RELATED APPLICATIONS

This application claims priority from European Patent Application No. 24175540.4, which was filed on May 13, 2024, and is incorporated herein in its entirety by reference.

This document describes a technique to separate a speech signal from the background in an audio mixture for an arbitrary number of channels. The separated speech and background signals can then be used to enable audio personalization in, e.g., object-based audio. The technique here-disclosed is also called ASIP (Automatic Signal Projection).

### BACKGROUND OF THE INVENTION

The proposed method enables the separation of the speech signal using a single-channel source separation method by estimating a number of projection coefficients, which when applied to the single-channel speech signal estimate, recover the multichannel desired signal. The estimation of the projection coefficients is carried out per sample/time-frame, thus enabling the tracking of time-varying speaker position. Finally, the proposed method, enables the application of single-channel source separation methods to an arbitrary number of channels.

### Envisioned Application

The envisioned application of the method described by this report is to enable object-based audio (OBA), e.g., as realized by MPEG-H Audio [1, 2], for any type of audio content. In particular, MPEG-H allows for personalization on the decoder side such that the relative level difference between the dialogue and background, e.g., in a movie track, is set by the user. This is especially important as this level difference is shown to be highly subjective [3, 4]. While OBA functionalities rely on access to separate audio objects, only a mixture signal is available for a wide range of content, rendering DS (dialogue separation) (or more in general target signal separation) needed. DS processes a given mixture to estimate the dialogue and background audio objects. The vast majority of DS solutions are capable of processing monaural and stereo mixtures, e.g., [5], however, many mixtures are of a higher number of channels, e.g., 5.1 or 7.1 mixtures. For such mixtures it is important to extract the audio objects blindly without distorting the dialogue's spatial image/position. The method described in this document (and depicted in FIGS. 1-3) enables DS (and more in general target signal separation) methods for an arbitrary number of channels by generalizing pre-trained monaural deep-neural-network-(DNN)-based DS (or more in general target signal separation) without the need to train for multichannel mixtures, and while preserving the position of the extracted audio objects.

Another application of the proposed method is to enable multichannel dialogue enhancement independently from OBA. This is done by generating a dialogue-enhanced mixture by remixing the dialogue and an attenuated background objects. This is particularly relevant for conventional broadcasting and streaming applications where OBA is not available or supported, but instead, several audio mixtures are pre-generated on the server side and the user is offered the choice between original and dialogue-enhanced mixtures.

Also, multichannel dialogue-enhancement at the end-user device can be enabled via the proposed method, where the audio objects are estimated and remixed on the consumer device.

Dialogue Separation (or more in general target signal separation)

For a number of channels M>1, a given mixture signal 2 can be described as

$${y}_{m} ( n ) = {s}_{m} ( n ) + {v}_{m} ( n ) , ∀ m ∈ [ 1 , … , M ] , \qquad ( 1 )$$

where n denotes the discrete-time index, yₘ(n) denotes the m-th channel mixture signal (with 1≤m≤M). This formulation decomposes the mixture signal yₘ(n) (2) into two components:
sₘ(n) which comprises the speech/dialogue (or more in general target) components (which together form an array of multi-channel target (or dialogue) signal) and,
vₘ(n) that denotes the background signal components which include, e.g., musical instruments, noise signals, and effects.

Consequently, the task of DS (or more in general target signal separation) can be described as estimating the two signal components per channel, i.e. ŝₘ(n) and \hat{v}ₘ(n). Furthermore, by enforcing that yₘ(n)=\hat{v}ₘ(n)+Îₘ(n), the estimation of vₘ(n) can be carried out as \hat{v}ₘ(n)=yₘ(n)−ŝₘ(n), and the overall problem is reduced to extracting the dialogue signal sₘ(n), which is a focus in this document.

To separate the target (e.g. speech) signal from the background for single-channel mixtures, i.e., M=1, numerous methods can be found in the literature including, e.g., model-based methods [6]. More recently, deep learning-based solutions [7, 8, 9] have attracted significant attention due to their impressive results and speech extraction capabilities.

### Multichannel Dialogue Separation: Prior-Art and Related Works

Extending single-channel methods to stereo mixtures is rather straightforward when assuming centered dialogue signals which enables, e.g., processing the phantom center mixture channel, and subsequently recovering a stereo speech signal as double mono. This, however, underscores two challenges for multichannel DS, namely,
Panned dialogue stereo signals: where the dialogue signal is rendered differently in different channels

$${s}_{m} ( n ) \neq {s}_{i} ( n ) ∀ i \neq m , \qquad ( 2 )$$

which violates the centered-dialogue assumption mentioned earlier.
The general case of mixture with M>2 channels with unknown speech position, which are especially relevant as they include, e.g., the 5.1 format.

To address panned dialogues in stereo signals, a naive approach would be to filter the channels separately by a monaural DS system. This approach, however, can render a multichannel dialogue signal with inter-channel phase distortions, which can represent a significant disturbance for the listener.

Alternatively, rotation-based methods are proposed. For instance, the authors in [2] propose an algorithm which operates by finding a rotation of the stereo scene that makes the energies of the rotated channels equal, based on the assumption that by doing so, the center of the rotated scene points at the primary direct audio. Consequently, after filtering the center of the rotated signal, the original stereo dialogue signal can be recovered by inverting the rotation.

Finally, inherent multichannel DS methods can also be found in the literature. This class of methods describes typically a DNN with multiple input signals (each corresponding to a channel of the mixture) and multiple outputs (each corresponding to a channel of the estimated dialogue

signal). An example of such methods is found in [10], which proposes a multiple-input/multiple-output variant of the monaural bandsplit recurrent neural network [9].

Nevertheless, while these methods enable DS for multichannel mixtures, they suffer from clear limitations:

The naive approach of filtering channels separately can indeed render a multichannel dialogue signal estimate. However, they can introduce significant spatial distortions. In addition, the computational cost of such methods grows linearly with the number of channels in the mixture, rendering them computationally expensive for a large number of channels.

Rotation-based methods are formulated for the case of stereo mixtures and generalizing them to arbitrary number of channels and formats remains unclear and would potentially constitute a significant computational overhead compared to single-channel DS. Furthermore, as the rotation parameters are estimated from the input mixture only, such methods' performance at low SNR is degraded (SNR in this context may refer to the dialogue to non-dialogue power ratio).

Inherent multichannel DS methods (e.g., [10]) are relatively straightforward to implement. However, their computational complexity is often much larger than that of monaural DS methods. Furthermore, as these are data-driven methods, pre-training for a target number of channels is needed. Therefore, generalization to arbitrary number of channels is not guaranteed without training. It is important at this point to underline the difficulty of training for multichannel signals as the data needed to capture such use-cases is not abundant and is, indeed, challenging to obtain. Moreover, as such methods typically apply different complex-valued masks to different mixture channels, phase-related distortions may occur, which represent a significant disruption to the listener.

An overview of ASIP (automatic signal projection) signal flow, where a multichannel mixture is first downmixed to a single-channel mixture. The single-channel mixture y(n) is processed by a monaural DS to extract a single-channel estimate of the dialogue signal ŝ(n). The ASIP recovers a multichannel estimate of the dialogue based on the multichannel mixture

$${\{ {y}_{m} ( n ) \}}_{m = 1}^{M}$$

ŝ(n).

### SUMMARY

According to an embodiment, a system for deriving, from an input multi-channel audio signal, a multi-channel target signal in compressed form, may have:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels; and
an output unit to output the multi-channel target signal in compressed form as the single-channel target signal and the array of multi-channel projection coefficients.

According to another embodiment, a system for deriving, from an input multi-channel audio signal, a multi-channel target signal in compressed form, may have:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels, and
an output unit to output the multi-channel target signal in compressed form as the single-channel target signal and the array of multi-channel projection coefficients,
wherein the multi-channel projection coefficients estimation block is configured to, in at least one step:
retrieve the array of multi-channel projection coefficients by minimizing, for each channel, a channel-specific cost function which is an expectation of a difference, or a quadratic version of the difference or another norm of the difference, between the channel in the input multi-channel audio signal, taken in magnitude or another norm, and a corresponding estimate of the channel of the multi-channel target signal, taken in magnitude or another norm, the estimate of the channel of the multi-channel target signal taken in magnitude or another norm being derived by scaling the single-channel target signal, taken in magnitude or another norm, by a candidate projection coefficient, so that the array of candidate projection coefficients which minimizes the cost functions is chosen as the array of multi-channel projection coefficients.

According to another embodiment, a method for deriving, from an input multi-channel audio signal, a multi-channel target signal in compressed form, may have the steps of:
downmixing the input multi-channel audio signal onto one single-channel downmix signal;
performing a single-channel separation of the single-channel downmix channel, to derive a single-channel target signal from the single-channel audio signal,
deriving an array of multi-channel projection coefficients projecting the single-channel target signal onto multiple channels; and
outputting the multi-channel target signal in compressed form as the single-channel target signal and the array of multi-channel projection coefficients.

Another embodiment may have a non-transitory digital storage medium having a computer program stored thereon to perform the method for deriving, from an input multi-channel audio signal, a multi-channel target signal in compressed form, when said computer program is run by a computer.

In accordance to an aspect, there is provided a system for deriving, from an input multi-channel audio signal, a multi-channel target signal in compressed form, the system comprising:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels; and
an output unit to output the multi-channel target signal in compressed form as the single-channel target signal and the array of multi-channel projection coefficients.

In accordance to an aspect, the system may be such that the multi-channel projection coefficients estimation block is configured to, in at least one step:
derive a first array of estimates of the projection coefficients from a version of the projection coefficients of the preceding step;
derive an array of errors between the input multi-channel audio signal, or a magnitude or another norm of it, and the estimates of the first array of estimates, or a magnitude or another norm of it;
update the first array of estimates of the projection coefficients with an array of corrections, to thereby derive a second, updated array of estimates of the projection coefficients, so that the second, updated array of the estimates constitute the array of multi-channel projection coefficients, or a predecessor of the array of multi-channel projection coefficients.

In accordance to an aspect, the system may be such that the multi-channel projection coefficients estimation block is configured to, in the at least one step:
derive the array of errors between the input multi-channel audio signal, taken in magnitude or another norm, and the estimates of the first array of estimates, taken in magnitude or another norm.

In accordance to an aspect, the system may be such that the multi-channel projection coefficients estimation block is configured to derive the array of corrections by scaling the array of errors by Kalman gain(s), or other coefficient(s) comparatively large for comparatively large posterior variance, comparatively small for comparatively small posterior variance, comparatively large for comparatively small observation noise variance, and comparatively small for comparatively large variance.

In accordance to an aspect, the system may be such that the multi-channel projection coefficients estimation block is configured to average the projection coefficients of the second, updated array of estimates along the frequencies, to thereby derive the array of multi-channel projection coefficients, or a predecessor version thereof, common to all the frequencies.

In accordance to an aspect, the system may be such that the multi-channel projection coefficients estimation block is configured to normalize the projection coefficients of the second, updated array of estimates, or an averaged or otherways processed version thereof.

In accordance to an aspect, the system may be such that the multi-channel projection coefficients estimation block is configured to derive the first array of estimates by scaling the array of multi-channel projection coefficients of the preceding step by a constant parameter larger than 0 and smaller than 1.

In accordance to an aspect, the system may be such that the first array of estimates is common for all the frequencies.

In accordance to an aspect, the system may be such that the multi-channel projection coefficients estimation block is configured to derive the Kalman gain(s), or the other coefficient(s), as ratio(s) between:
a product between the density variance and the magnitude, or another norm, of the single-channel target signal at the ratio's numerator; and
a sum between the observation noise variance and a product between the energy of the single-channel target signal and the density variance at the ratio's denominator.

In accordance to an aspect, the system may further comprise a target signal selector configured to channel-wise select the channels in which the target signal is present, thereby discarding the non-selected channels, the non-selected channels bypassing the single-channel separation block and the multi-channel projection coefficients estimation block.

In accordance to an aspect, the system may be further configured to convert the single channel downmix signal from the time domain to a time-frequency domain.

In accordance to an aspect, the system may be such that the single-channel separation block is realized by a neural network.

In accordance to an aspect, the system may be such that the single-channel separation block is configured to perform a deterministic separation.

In accordance to an aspect, the system may be such that the target signal is a voice component.

In accordance to an aspect, the system may be configured to output the multi-channel target signal in compressed form as a foreground object described by the array of multi-channel projection coefficients and the single-channel target signal, and a multi-channel background object as the difference between the input multi-channel audio signal and a decompressed version of the multi-channel target signal.

In accordance to an aspect, the system may be configured to derive the decompressed version of the multi-channel target signal by scaling the single-channel target signal by the array of multi-channel projection coefficients.

In accordance to an aspect, the system may be such that the input multi-channel audio signal is in a non-object-based format.

In accordance to an aspect, the system may be configured to transmit the multi-channel target signal in compressed form.

In accordance to an aspect, the system may be such that the downmix block is configured to downmix the input multi-channel audio signal by adding with each other the values of the input multi-channel audio signal.

In accordance to an aspect, there is provided a system for deriving, from an input multi-channel audio signal, a multi-channel target signal in compressed form, the system comprising:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels, and
an output unit to output the multi-channel target signal in compressed form as the single-channel target signal and the array of multi-channel projection coefficients,
wherein the multi-channel projection coefficients estimation block is configured to, in at least one step:
retrieve the array of multi-channel projection coefficients by minimizing, for each channel, a channel-specific cost function which is an expectation of a difference, or a quadratic version of the difference or another norm of the difference, between the channel in the input multi-channel audio signal, taken in magnitude or another norm, and a corresponding estimate of the channel of the multi-channel target signal, taken in magnitude or another norm, the estimate of the channel of the multi-channel target signal taken in magnitude or another norm being derived by scaling the single-channel target signal, taken in magnitude or another norm, by a candidate projection coefficient, so that the array of candidate projection coefficients which minimizes the cost functions is chosen as the array of multi-channel projection coefficients.

In accordance to an aspect, the system may be such that the projection coefficients estimation block is configured to, in the at least one step:
derive a first array of estimates of the projection coefficients from a version of the projection coefficients of the preceding step;
derive an array of errors between the input multi-channel audio signal, taken in magnitude or another norm, and the estimates of the first array of estimates, taken in magnitude or another norm;
update the first array of estimates of the projection coefficients with an array of corrections, to thereby derive a second, updated array of estimates of the projection coefficients, so that the second, updated array of the estimates constitute the array of multi-channel projection coefficients, or a predecessor of the array of multi-channel projection coefficients,
wherein the array of corrections is derived by scaling the array of errors by Kalman coefficient(s), or another coefficient which is comparatively large for comparatively large posterior variance, comparatively small for comparatively small posterior variance, comparatively large for comparatively small observation noise variance, and comparatively small for comparatively large variance.

In accordance to an aspect, there is provided a method for deriving, from an input multi-channel audio signal, a multi-channel target signal in compressed form, the system comprising:
downmixing the input multi-channel audio signal onto one single-channel downmix signal;
performing a single-channel separation of the single-channel downmix channel, to derive a single-channel target signal from the single-channel audio signal,
deriving an array of multi-channel projection coefficients projecting the single-channel target signal onto multiple channels; and
outputting the multi-channel target signal in compressed form as the single-channel target signal and the array of multi-channel projection coefficients.

In accordance to an aspect, there is provided a non-transitory storage unit storing instructions which, when executed by a processor, cause the processor to perform the method according to the method above.

### BRIEF DESCRIPTION OF THE DRAWINGS

Embodiments of the present invention will be detailed subsequently referring to the appended drawings, in which:

FIGS. 1-3 show examples of systems according to the present technique.

### DETAILED DESCRIPTION OF THE INVENTION

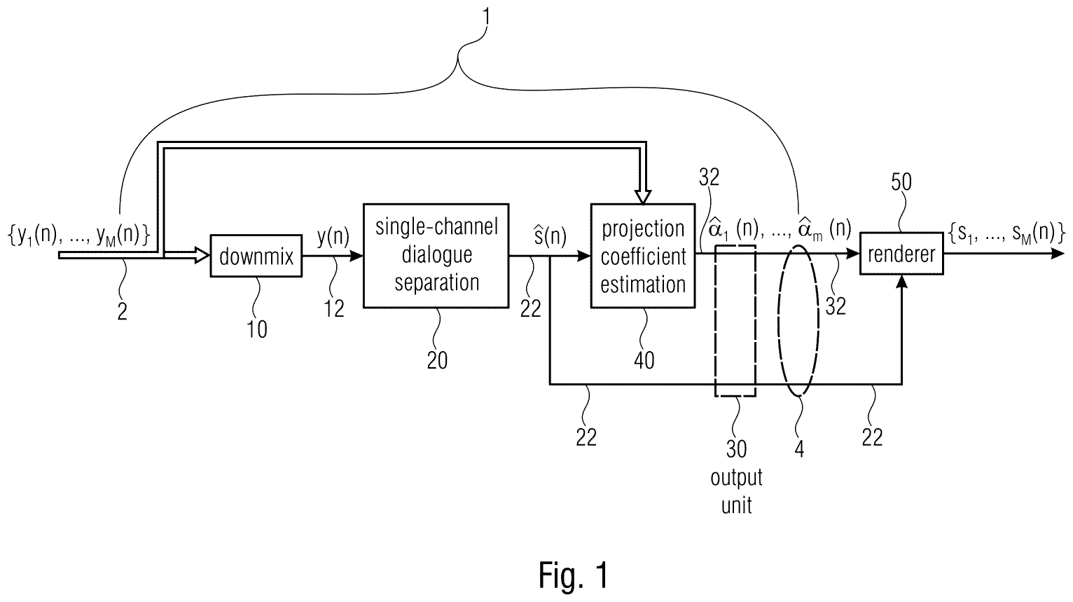

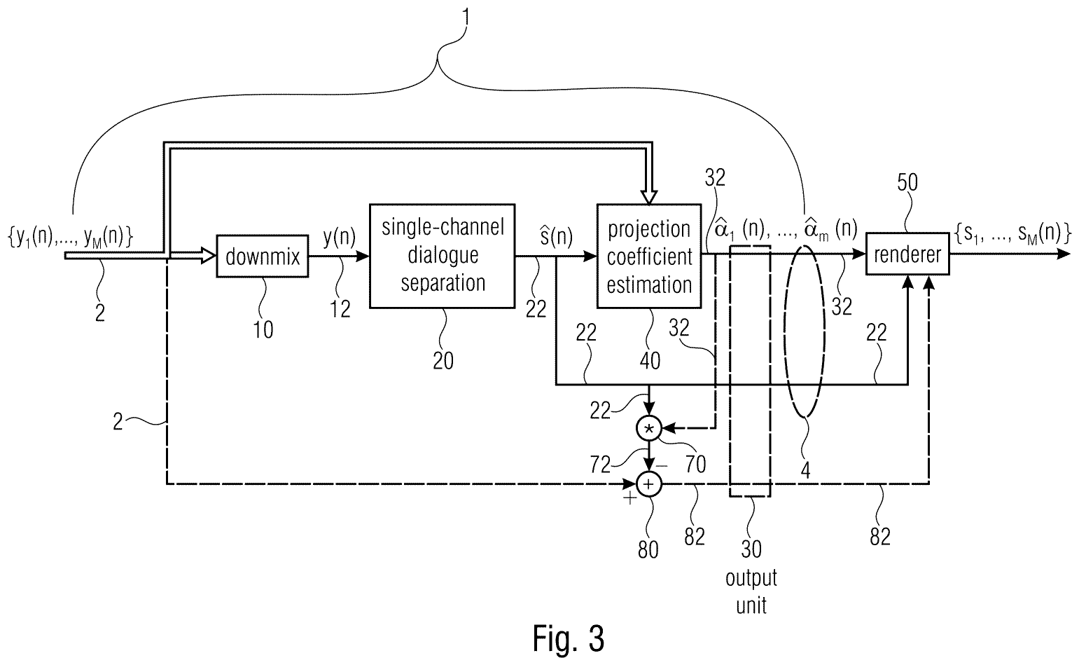

FIG. 1 shows a system 1, which may be an audio encoder or part of an audio encoder. The system 1 may receive in input an input multi-channel audio signal 2 having M channels (each channel being indicated with y₁(n) . . . , y_{M}(n)). The system 1 may output a multi-channel target signal 4 in compressed form. The outputted multi-channel target signal 4 in compressed form may be of the type having one single-channel target signal 22 (expressed as ŝ(n)) and an array of projection coefficients (array of multi-channel projection coefficients) 32 which (when scaling the single-channel target signal 22) project the single-channel target signal (22) onto multiple channels (it will be shown e.g. with reference to FIG. 3 that it is also possible that more than one channel is present in the output signal, e.g. in the case in which the outputted multi-channel target signal 4 is a foreground object, and a multi-channel background object is also encapsulated in the output signal).

The system 1 may include a downmix block 10, to downmix the input multi-channel audio signal (y₁(n) . . . , y_{M}(n)) 2 onto one single-channel downmix signal y(n) indicated with 12, where n is the time instant (the input multi-channel audio signal is here hypothesized in the time domain, but it could also be in the frequency domain, or it could be converted from time domain onto the frequency domain by the system 1). The downmix block 10 may downmix the input multi-channel audio signal 2 in various ways. For example, the downmix block 10 may sum with each other the m values of the input multi-channel audio signal, so as to obtain a single-channel version of the input multi-channel audio signal 2.

The system 1 may include a single-channel separation block 20, to perform a single-channel separation of the single-channel downmix channel 12. Therefore, the single-channel separation block 20 may obtain the single-channel target signal (n) (22) from the single-channel audio signal 12.

The single-channel separation block 20 may include a neural network (e.g. DNN) trained, for example, to perform a single-channel separation. Since neural networks need a great amount of computational power, the fact that only one single channel is processed by the single-channel separation block 20 greatly reduces the computational power needed for the target signal separation in respect to a neural network performing a multi-channel target signal separation.

In other examples, the single-channel separation block 20 may perform a deterministic single-channel separation technique. In this case, the training is not required. Some of these deterministic techniques are also efficient computationally.

The system 1 may include a multi-channel projection coefficients estimation block 40, to derive the array of multi-channel projection coefficients 32 which are capable of projecting the single-channel target signal (22) onto multiple channels. It will be shown that the multi-channel projection coefficients 32 (indicated with am (t) for the m-th channel for the time bin t) may be obtained by multiple refining, e.g. using

$${\hat{α}}_{m}^{+} ( τ , f ) , {\hat{α}}_{m}^{+ +} ( τ ) , etc . ) .$$

The multi-channel projection coefficients estimation block 40 may implement, for example, a Kalman filter to estimate the multi-channel projection coefficients 32 from a first, gross estimation (e.g. obtained from a previous step) to a finer estimation.

The system may include an output unit 30. The output unit 30 may output the multi-channel target signal 4 in compressed form as the single-channel target signal 22 and the array of multi-channel projection coefficients 32. In some examples, the output unit 30 may include an entropy coder for losslessly encoding the multi-channel target signal 4. The output unit 30 may transmit the multi-channel target signal 4 in compressed form to a receiver (e.g., through a communication network) and/or store the multi-channel target signal 4 in a storage unit (e.g., a mass memory). (It will be shown e.g. with reference to FIG. 3 that it is also possible that more than one channel is present in the output signal, e.g. in the case in which the outputted multi-channel target signal 4 is a foreground object, and a multi-channel background object is also encapsulated in the output signal).

A receiver may therefore receive the multi-channel target signal 4 and render it (e.g. in the renderer 50, which is therefore a remote (separated) device from the system 1). Or, the system 1 itself (e.g. after having stored it) may render the multi-channel target signal 4 (and in this case the renderer 50 is integrated in the system 1, and receives the multi-channel target signal 4 from the output unit 40). Therefore the renderer 50 in FIGS. 1-3 is optional and can be external to the system 1.

It is to be noted that the processed signal is indicated, in FIG. 1, in the time domain (n being the time instant). However, the multi-channel projection coefficients estimation block 40 may process the signal in the frequency domain: therefore, a converter from time domain to frequency domain may be provided upstream to the multi-channel projection coefficients estimation block 40 (e.g. upstream or downstream to the single-channel separation block 20, or upstream to the downmix block 10, or the input signal 2 may be received in the frequency domain). In addition or in alternative, a converter from frequency domain to time domain may be provided downstream to the multi-channel projection coefficients estimation block 40 (or in the output unit 40), or the multi-channel target signal 4 may be simply outputted in frequency domain.

The operation above are intended to be performed sequentially e.g. for each time-frequency bin, and are then repeated for the subsequent time-frequency bins. Notably, however, some information is maintained from one time-frequency bin to grossly estimate the immediately subsequent time-frequency bin (which is then to be refined).

### Automatic Signal Projection for Dialogue Separation

This section describes a novel approach (in some cases also denoted ASIP) to multichannel DS (or more in general target-signal separation) which addresses the different challenges and limitations observed earlier for alternative methods.

As example above, the multi-channel projection coefficients estimation block 40 may operate iteratively at each time τ. Time t may be a frame of time-frequency bins. Notably, some passages are differentiated for different frequencies of the time-frequency bins.

The multi-channel projection coefficients estimation block 40 may derive the multi-channel target signal 4 in compressed form as the single-channel target signal 22 and the multi-channel projection coefficients 32. The multi-channel projection coefficients estimation block (40) may, in at least one step (e.g. at least for one step τ>1, i.e. at least for one step after the initial step):
derive a first array of estimates

$$[ e . g . {\hat{α}}_{m}^{+} ( τ , f )$$

in formula (10) below of the projection coefficients from a version of the projection coefficients of the preceding step T-1;
derive (e.g. through formula (12) below) an array of errors (one error Eₘ(τ, f) for each m-th channel and, for example, for each time-frequency bin) between the input multi-channel audio signal, or a magnitude or another norm of it, and the estimates of the first array of estimates, or a magnitude or another norm of it (e.g. through

$$\vert {Y}_{m} ( τ , f ) \vert - {\hat{α}}_{m}^{+} ( τ , f ) \cdot \vert \hat{S} ( τ , f ) \vert ) ;$$

update the first array of estimates of the projection coefficients with an array of corrections [e.g. k.Eₘ], to thereby derive a second, updated array of estimates

$$[ {\hat{α}}_{m}^{u} ( τ , f ) ]$$

of the projection coefficients, so that the second, updated array of estimates

$$[ {\hat{α}}_{m}^{u} ( τ , f ) ]$$

either constitutes the array of multi-channel projection coefficients, or a predecessor of the array of multi-channel projection coefficients. The final version may be obtained after averaging on the frequencies, e.g.

$${\hat{α}}_{m}^{++} ( τ ) = \frac{1}{F} \cdot {\sum }_{f = 1}^{F} {\hat{α}}_{m}^{u} ( τ , f )$$

e.g. with formula (17) below, and/or normalization e.g.

$${\hat{α}}_{m} ( τ ) = \frac{{\hat{α}}_{m}^{++} ( τ )}{{\sum }_{m = 1}^{M} {\hat{α}}_{m}^{++} ( τ )}$$

e.g. with formula (18) below. The corrections may be obtained, for example, with a Kalman gain

$${k}_{m} ( τ , f ) = \frac{{P}_{m} ( τ , f ) \cdot \vert \hat{S} ( τ , f ) \vert}{{\vert \hat{S} ( τ , f ) \vert}^{2} \cdot {P}_{m} ( τ , f ) + {σ}_{v , m}^{2} ( τ , f )}$$

(e.g. obtained like in formula (14) below).

Therefore, a Kalman-like filter is obtained: first, a first, coarse estimate

$${\hat{α}}_{m}^{+} ( τ , f )$$

of the coefficients is obtained from the previous step, and then the coarse estimate is refined by taking into consideration the error caused, to obtain the refined version

$${\hat{α}}_{m}^{u} ( τ , f ) .$$

The Kalman gain kₘ may be:
comparatively large for comparatively large posterior variance,
comparatively small for comparatively small posterior variance.

In addition or alternatively, the Kalman gain km may be:
comparatively large for comparatively small observation noise variance, and
comparatively small for comparatively large variance.

The considerations above may be generalized as follows: the multi-channel projection coefficients estimation block 40 may retrieve the array of multi-channel projection coefficients by minimizing, for each m-th channel, a channel-specific cost function (e.g. indicated with [symbol] ₘ(Yₘ(τ, f), Ŝₘ(τ, f)) in formula (9) below) and may be expressed as an expectation εₘ of a difference, or a quadratic version of the difference or another norm of the difference, between the channel in the input multi-channel audio signal 2, taken in magnitude or another norm (|Yₘ(τ, f)|), and a corresponding estimate of the channel of the multi-channel target signal, taken in magnitude or another norm, the estimate of the channel of the multi-channel target signal taken in magnitude or another norm being derived by scaling the single-channel target signal [Ŝm(τ, f)], taken in magnitude or another norm, by a candidate projection coefficient, so that the array of candidate projection coefficients which minimizes the cost functions is chosen as the array of multi-channel projection coefficients. An example of the cost function is [symbol] ₘ(Yₘ(τ, f), Ŝₘ(τ, f))=εₘ {(|Yₘ(τ, f)|−|Ŝₘ(τ, f)|)²}. The different cost functions are calculated independently of each other (e.g. each minimization is obtained independently of the other minimizations).

As depicted in FIGS. 1-3, there may be the following operations
Downmixing (e.g. at the downmix block 10) the original multichannel mixture 2 to obtain the single-channel mixture y(n) (single-channel downmix signal 12).
Processing (e.g. at the single-channel separation block 20) the downmixed signal y(n) (2) e.g. by a monaural DS technique (e.g. method) to obtain the single-channel dialogue signal § (n) (or more in general the single-channel target signal 22)·
Estimating (e.g. at multi-channel projection coefficients estimation block 40) the projection coefficients

$${\{ {α}_{m} ( n ) \}}_{m = 1}^{M}$$

such that the dialogue (target) signals

$${\{ {\hat{s}}_{m} ( n ) \}}_{m = 1}^{M}$$

recovered.

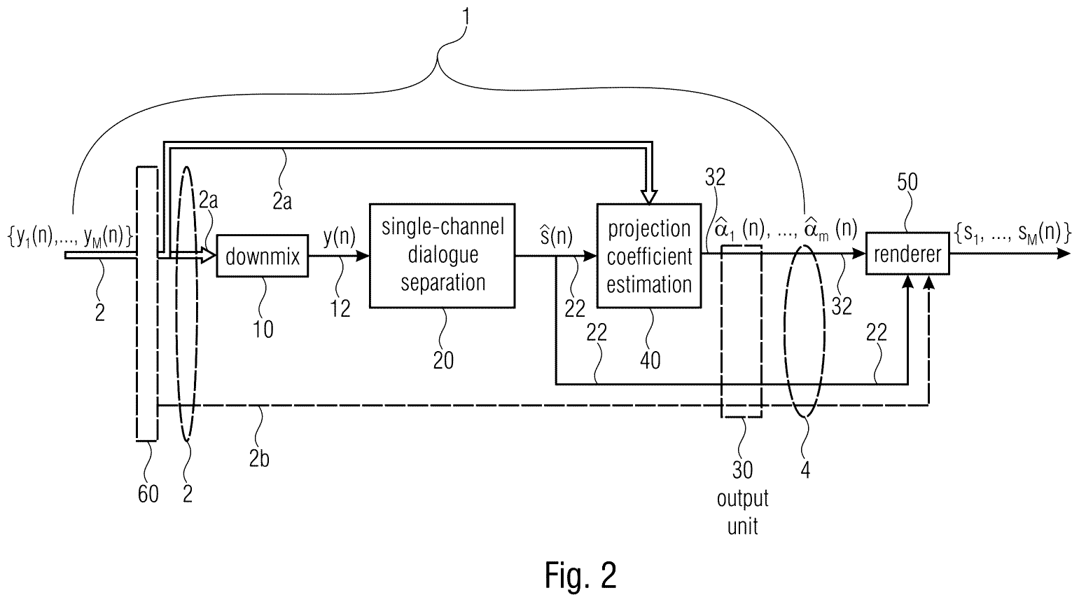

In some examples (e.g. in FIG. 2), there may be a selection (e.g. performed by a target signal selector 60) of some channels 2a to be processed, while some other channels 2b bypass the processing. Therefore, the target signal selector 60 may channel-wise select the channels in which the target signal is present, thereby discarding the non-selected channels 2b, the non-selected channels 2b bypassing the single-channel separation block 20 and the multi-channel projection coefficients estimation block 30. This has the advantage of maintaining a high quality for at least the non-selected channels 2b. The selection performed by the target signal selector 60 may be based on a priori knowledge or on a coarse signal analysis, which pre-emptively discards the channels 2b which are determined as not containing the target signal (e.g. speech). The target signal selector 60 may be deterministic, for example (e.g. not a neural network). The target signal selector 60 (whether learnable or deterministic) may have a computational complexity which is less than the computational complexity than the multi-channel projection coefficients estimation block 30.

It is to be noted that in some examples also the background may be outputted. This is shown in FIG. 3. The system 1 may therefore output:
the multi-channel target signal 4 in compressed form as foreground object described by the array of multi-channel projection coefficients 32 and the single-channel target signal 22, and
a multi-channel background object 82 as the difference (e.g. obtained at the subtraction block 80) between the input multi-channel audio signal 2 and a decompressed version 72 of the multi-channel target signal 22 (e.g. obtained by scaling, at scaler 70, the single-channel target signal 22 by the array of multi-channel projection coefficients 32).

Therefore, it is possible to convert the input signal 2 from a non-object based version onto an object based version.

### Signal Model

ASIP (e.g. at the downmix block 10) may model the m-th channel of the mixture signal by

$${y}_{m} ( n ) = {s}_{m} ( n ) + {v}_{m} ( n ) \qquad ( 3 )$$

$$= {α}_{m} ( n ) \cdot s ( n ) + {v}_{m} ( n ) \qquad ( 4 )$$

where sₘ(n) denotes the dialogue (or more in general target) signal (or more in general a component of the single-channel target signal 22) in the m-th channel, s (n) denotes the source dialogue signal (which we don't know, but which we estimate with the present technique), while αₘ(n) is the m-th projection coefficient which determines the gain applied to the source dialogue signal when observed in the m-th channel (collectively, the αₘ(n) for m∈[1, . . . , M] may constitute the array of multi-channel projection coefficients 32), and “ ” denotes the multiplication. Furthermore, we may assume that

$$s ( n ) = {\sum }_{m = 1}^{M} {s}_{m} ( n ) , \qquad ( 5 )$$

or in other terms,

$${\sum }_{m = 1}^{M} {α}_{m} ( n ) = 1. \qquad ( 6 )$$

As depicted in FIGS. 1-3, ASIP relies on processing (e.g. at downmix block 10) a single-channel downmix of the multichannel mixture 2. For instance, such downmix can be obtained by simply summing the M channels of the mixture:

$$y ( n ) = {\sum }_{m = 1}^{M} {y}_{m} ( n ) = s ( n ) + v ( n ) . \qquad ( 7 )$$

The downmixed signal y(n) may then be processed by a monaural DS technique (e.g. monaural DS method) (or more in general target-signal separation technique) to estimate the source dialogue signal

$$\hat{s} ( n ) = DS ( y ( n ) ) . \qquad ( 8 )$$

The task of ASIP is then simplified to estimating the projection coefficients

$${\{ {α}_{m} ( n ) \}}_{m = 1}^{M}$$

such that

$${\{ {\hat{s}}_{m} ( n ) \}}_{m = 1}^{M}$$

are recovered.

ASIP may operate in the time-frequency domain, where for each time-frequency bin (τ, f), ASIP goal can be formulated as minimizing a loss function [symbol] ₘ(cost function) such as the loss function

$${𝒥}_{m} ( {Y}_{m} ( τ , f ) , {\hat{S}}_{m} ( τ , f ) ) = {ℰ}_{m} \{ {( \vert {Y}_{m} ( τ , f ) \vert - \vert {\hat{S}}_{m} ( τ , f ) \vert )}^{2} \} , \qquad ( 9 )$$

such that |Ŝₘ(τ, f)|=\hat{α}ₘ(τ, f)·|Ŝ(τ, f)|. ε(·) denotes the expectation operator (e.g. mathematical expectation operator), \hat{α}ₘ (τ, f) denotes the m-th projection coefficient estimate at time-frequency bin (τ, f), and | . . . | is a norm (e.g. magnitude, e.g. the absolute value).

### Adaptive Filtering-based Implementation

In an embodiment, ASIP (e.g. at block 40) may solve formula (9) e.g. iteratively via Kalman filtering [11], which can be summarized by the following steps for each new time-frame t (time-frequency bin).

The processing steps can be summarized as:
Latent state progression

$${\hat{α}}_{m}^{+} ( τ , f ) = A \cdot {\hat{α}}_{m} ( τ - 1 , f ) , \qquad ( 10 )$$

where A is a constant parameter often chosen close to but slightly below 1 (e.g. A=0.8, or A=0.9 or more advantageous A=0.95, or another value e.g. A>0.8, or, even more advantageous, A>0.9), while \hat{α}(τ−1, f) denotes the estimate of am at the previous time-frame (e.g. at a step in which formula (18) is processed for the preceding time-frame, τ−1). In some exantpres,

$${\hat{α}}_{m} ( τ - 1 , f )$$

invariant with the frequency, and therefore it could be written \hat{α}ₘ (τ−1). Hence,

$${\hat{α}}_{m}^{+} ( τ , f )$$

could be written in principle as

$${\hat{α}}_{m}^{+} ( τ ) .$$

However, as it will become apparent in the next passages, subsequent processing may vary at the varying of the frequency, and therefore there may be a plurality of processed versions of

$${\hat{α}}_{m}^{+} ( τ ) .$$

For this reason, we favor to use the notation

$${\hat{α}}_{m}^{+} ( τ , f ) .$$

The values

$${\hat{α}}_{m}^{+} ( τ , f )$$

for m∈[1, . . . , M] understood as collectively forming a first array of estimates of the projection coefficients.
Posterior density variance update (which may vary with the frequency, and the channels) can be obtained with

$${P}_{m} ( τ , f ) = A \cdot {{P}_{m}}^{+} ( τ - 1 , f ) + Q ( τ , f ) , \qquad ( 11 )$$

where Q(τ, f) denotes the process noise variance (a constant parameter that is pre-chosen and may be set to a value chosen within the interval [10⁻⁴, 10⁻⁵] but it may vary with the frequency and/or may be unique for all the channels, i.e. it may be independent from the channel), while Pₘ⁺(τ−1, f) denotes the previously predicted posterior density variance and may vary with the frequency and the channels, and A may be the same value of formula (10).
Error signal calculation can be performed with

$${E}_{m} ( τ , f ) = \vert {Y}_{m} ( τ , f ) \vert - {\hat{α}}_{m}^{+} ( τ , f ) \cdot \vert \hat{S} ( τ , f ) \vert . \qquad ( 12 )$$

where Yₘ(τ, f) is the m-th channel of the input multi-channel audio signal 2, Ŝ(τ, f) is the single-channel target signal 22, and | . . . | is a norm (e.g. magnitude, e.g. absolute value). Notably, there may be different errors for different channels (i.e. Eₘ (τ, f) is varies with the channel). Eₘ can vary with the frequencies and the channels.
Updating the observation noise variance (which may vary with different frequencies) may be performed with

$${σ}_{v , m}^{2} ( τ , f ) = λ \cdot {σ}_{v , m}^{2} ( τ - 1 , f ) + ( 1 - λ ) \cdot {\vert {E}_{m} ( τ , f ) \vert}^{2} , \qquad ( 13 )$$

where λ is the recursive averaging constant that is selected beforehand (and may be taken from the interval [0.9,0.99]), and | . . . | is a norm (e.g. magnitude, e.g. absolute value). Notably, there are different errors for different channels. Notably, there may be different observation noise variances

$${σ}_{v , m}^{2}$$

for different channels of the time-frequency bin.
A Kalman gain calculation may be performed with

$${k}_{m} ( τ , f ) = \frac{{P}_{m} ( τ , f ) \cdot \vert \hat{S} ( τ , f ) \vert}{{\vert \hat{S} ( τ , f ) \vert}^{2} \cdot {P}_{m} ( τ , f ) + {σ}_{v , m}^{2} ( τ , f )} , \qquad ( 14 )$$

where Pₘ(τ, f) is the posterior density variance obtained e.g. with formula (11), Ŝ (τ, f) is the single-channel target signal 22 (e.g. as obtained from block 20),

$${σ}_{v , m}^{2}$$

(τ, f) is the observation noise variance updated with formula (13), for example, and | . . . | is a norm (e.g. magnitude, e.g. absolute value). Notably, there are different errors for different channels. Notably, there are different Kalman gains for different channels (i.e. there may be an array of Kalman gains, each for each channel). The Kalman gain may vary with the frequencies.
Corrections are obtained (e.g. for each channel and/or for each frequency) as

$${k}_{m} ( τ , f ) \cdot {E}_{m} ( τ , f )$$

where kₘ(τ, f) is the Kalman gain (e.g. for the particular m-th channel) as obtained with formula (14) and Eₘ(τ, f) is the error (specific of the particular m-th channel) as obtained with formula (12).
Based on the error signal, the projection coefficients may be updated by

$${\hat{α}}_{m}^{u} ( τ , f ) = {\hat{α}}_{m}^{+} ( τ , f ) + {k}_{m} ( τ , f ) \cdot {E}_{m} ( τ , f ) \qquad ( 15 )$$

where

$${\hat{α}}_{m}^{+} ( τ , f )$$

is taken from the first array of estimates of the projection coefficients as obtained with formula (10), and the correction kₘ(τ, f)·Eₘ (τ, f) is the obtained correction for the m-th channel.

$${\hat{α}}_{m}^{+} ( τ , f )$$

may therefore vary with both the channel and the frequency.
The posterior variance is updated as

$${P}_{m}^{+} ( τ , f ) = ( 1 - {k}_{m} ( τ , f ) \cdot \vert \hat{S} ( τ , f ) \vert ) \cdot {P}_{m} ( τ , f ) . \qquad ( 16 )$$

where kₘ (τ, f) is the Kalman gain for the m-th channel as obtained with formula (14), Ŝ(τ, f) is the single-channel target signal 22, Pₘ (τ, f) is the posterior density variance as obtained with formula (11), and | . . . | is a norm (e.g. magnitude, e.g. absolute value).
To avoid frequency-dependent projection coefficients, the projection coefficients

$${\hat{α}}_{m}^{u}$$

e.g. as obtained with formula (15) may optionally be averaged over the frequency range

$${\hat{α}}_{m}^{+ +} ( τ ) = \frac{1}{F} . {\sum }_{f = 1}^{F} {\hat{α}}_{m}^{u} ( τ , f ) , \qquad ( 17 )$$

where F is the total number of frequencies of the time-frequency bin (the frequencies may be frequency bands).
Furthermore, optionally the estimated projection coefficients are normalized (i.e. forced to sum to 1), i.e.,

$${\hat{α}}_{m} ( τ ) = \frac{{\hat{α}}_{m}^{+ +} ( τ )}{{\sum }_{m = 1}^{M} {\hat{α}}_{m}^{+ +} ( τ )} . \qquad ( 18 )$$

Finally, the estimated projection coefficients are used, together with the single-channel target signal 22, as the target signal 4 in compressed form.

It will be possible to recover the dialogue signals {Ŝm(τ, f)}ₘ and the corresponding time-domain signals are obtained by an inverse time-frequency transform.

In the case in which also the background is to be outputted, then formulas (3) and (4) may be used. In particular, together with the multi-channel target signal 4 in compressed form as foreground object described by the array of multi-channel projection coefficients 32 and the single-channel target signal 22, also the multi-channel background object may be outputted as the difference (Um (n)) between the input multi-channel audio signal 2 and a decompressed versions of the multi-channel target signal 22.

$${v}_{m} ( n ) = {y}_{m} ( n ) - {α}_{m} ( n ) \cdot s ( n )$$

where αₘ(n)·s(n) for m between 1 and M is the decompressed version of the multi-channel target signal 22 as estimated.

Compared to conventional Kalman filter applications (e.g., system identification), the ASIP (present solution) differs at least in that it optimizes for the magnitude difference (e.g. described by formula (9)) (or another norm) instead of the signal difference. In this way, with the present solution it is possible to tolerate potential phase errors in Ŝ(τ, f) compared to S(τ, f).

Furthermore, compared to conventional Kalman filtering, the averaging and normalization steps may be added (formulas (17) and (18)) to fulfill the signal model described by formula (5).

It is also possible to reduce the computational complexity of ASIP by constraining the estimation of the projection coefficients to a limited frequency range, e.g., from 50 to 4 kHz, corresponding to frequency bands where dialogue is prominent.

The estimated multichannel dialogue signal

$${\{ {\hat{s}}_{m} \}}_{m = 1}^{M}$$

and its spatial position in the audio mixture can be used to either
Render a dialogue-enhanced mixture signal:
this can be achieved by, e.g., remixing the dialogue signal and the background signal using a gain factor,

$${y}_{DE , m} = {\hat{s}}_{m} ( n ) + γ ( n ) \cdot {\hat{v}}_{m} ( n ) , \qquad ( 19 )$$

where γ(n) denotes a gain factor applied to the background signal to increase the intelligibility of the resulting mixture which is often done at a constant integrated loudness level.
Enable OBA for originally non-OBA mixtures. In particular, the mixture

$${\{ {y}_{m} ( n ) \}}_{m = 1}^{M}$$

can be represented by a bed signal with M channels, and a dialogue object ŝ(n) accompanied by positional metadata derived from the set of projection coefficients

$${\{ {\hat{α}}_{m} \}}_{m = 1}^{M} .$$

### Comparison to Other Alternatives

Overall, ASIP results in several advantages when compared to other alternatives, namely
It generalizes a single-channel DS system to address multichannel and panned dialogues usecases.
This generalization is achieved without training for multichannel mixtures. This reduces the requirements of ASIP as such data is often scarce compared to single-channel mixtures.
ASIP is not dependent on the number of channels. This results in a single system that can be used directly for an arbitrary number of channels and formats.
Due to the formulation as an adaptive filtering-like solution, ASIP computational cost is minimal.
Due to the use of real-valued projection coefficients, ASIP does not introduce phase-related distortions when rendering the multichannel dialogue signal estimate.
Enables object audio-based functionality for non-object-based audio scenes by representing the audio scene as an M channel signal, a mono signal, and a set of projection coefficients as metadata.
Finally, ASIP can be used as a front-end speech enhancement method for multichannel signals for, e.g., telecommunication applications.

### Further Examples

Here, different inventive examples, embodiments and aspects are described. Also, the embodiments described in the following and/or previous chapters can be used individually, and can also be supplemented by any of the features in another chapter, or by any feature included in the claims. Also, it should be noted that individual aspects described herein can be used individually or in combination. Thus, details can be added to each of said individual aspects without adding details to another one of said aspects. It should also be noted that the present disclosure describes, explicitly or implicitly, features of a mobile communication device and of a receiver and of a mobile communication system. Thus, any of the features described herein can be used in the context of a mobile communication device anin the context of a mobile communication system (e.g. comprising a satellite).

Therefore, disclosed techniques are suitable for all fixed satellite services (FSS) and mobile satellite services (MSS). Moreover, features and functionalities disclosed herein relating to a method can also be used in an apparatus. Furthermore, any features and functionalities disclosed herein with respect to an apparatus can also be used in a corresponding method. In other words, the methods disclosed herein can be supplemented by any of the features and functionalities described with respect to the apparatuses. Also, any of the features and functionalities described herein can be implemented in hardware or in software, or using a combination of hardware and software, as described below. Depending on certain implementation requirements, examples may be implemented in hardware. The implementation may be performed using a digital storage medium, for example a floppy disk, a Digital Versatile Disc (DVD), a Blu-Ray (registered trademark) Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable. Generally, examples may be implemented as a computer program product with program instructions, the program instructions being operative for performing one of the methods when the computer program product runs on a computer. The program instructions may for example be stored on a machine-readable medium. Other examples comprise the computer program for performing one of the methods described herein, stored on a machine-readable carrier. In other words, an example of method is, therefore, a computer program having a program-instructions for performing one of the methods described herein, when the computer program runs on a computer. A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory. A further example comprises a processing unit, for example a computer, or a programmable logic device performing one of the methods described herein. A further example comprises a computer having installed thereon the computer program for performing one of the methods described herein. A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver. In some examples, a programmable logic device (for example, a field programmable gate array) may be used to perform some or all of the functionalities of the methods described herein.

In some examples, a field programmable gate array may cooperate with a microprocessor in order to perform one of the methods described herein. Generally, the methods may be performed by any appropriate hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### ASPECTS

The authors of this report propose the following aspects:

1. A system (depicted in FIG. 1) comprising at least one of:
A downmixing module 10 that processes the multichannel mixture 2 to generate a single-channel downmixed mixture 12.
A monaural DS system 20, which estimates a single-channel dialogue signal 22 given the downmixed mixture 12.
An ASIP module 40, which takes as input the multichannel mixture 2 and single-channel dialogue signal 22 to estimate a set of projection coefficients.

2. The described system can be realized using a Kalman filter, which allows ASIP to track time-varying speech position.

3. The described system can be optimized for the loss function in formula (9). This renders ASIP robust to phase-errors in the estimated monaural dialogue signal.

4. Combining ASIP with a pre-trained DNN-based monaural DS system generalizes the DS system to arbitrary number of channels and unknown speech position without the need to train for multichannel mixtures.

5. The described system enables OBA for non-OBA multichannel mixtures with arbitrary number of channels by transforming the multichannel mixtures into an OBA scene with positional metadata for the speech object.

### REFERENCES

[1] C. Simon, M. Torcoli, and J. Paulus, “MPEG-H audio for improving accessibility in broadcasting and streaming,” 2019.
[2] J. Paulus, M. Torcoli, C. Uhle, J. Herre, S. Disch, and H. Fuchs, “Source separation for enabling dialogue enhancement in object-based broadcast with MPEG-H,” J. Audio Eng. Soc, vol. 67, no. 7/8, pp. 510-521, 2019.
[3] M. Torcoli, A. Freke-Morin, J. Paulus, C. Simon, and B. Shirley, “Preferred levels for background ducking to produce esthetically pleasing audio for TV with clear speech,” J. Audio Eng. Soc, vol. 67, no. 12, pp. 1003-1011, 2019.
[4] D. Geary, M. Torcoli, J. Paulus, C. Simon, D. Straninger, A. Travaglini, and B. Shirley, “Loudness differences for voice-over-voice audio in TV and streaming,” J. Audio Eng. Soc, vol. 68, no. 11, pp. 810-818, 2020.
[5] M. Torcoli, C. Simon, J. Paulus, D. Straninger, A. Riedel, V. Koch, S. Wits, D. Rieger, H. Fuchs, C. Uhle, S. Meltzer, and A. Murtaza, “Dialog+in broadcasting: First field tests using deep-learning-based dialogue enhancement,” International Broadcasting Convention (IBC), 2021.
[6] V. Leplat, N. Gillis, and A. Ang, “Blind audio source separation with minimum-volume beta-divergence NMF,” IEEE Transactions on Signal Processing, vol. 68, pp. 3400-3410, 2020.
[7] Z. Wang, S. Cornell, S. Choi, Y. Lee, B. Kim, and S. Watanabe, “TF-GridNet: Making time-frequency domain models great again for monaural speaker separation,” International Conference on Acoustics, Speech, and Signal Processing, 2023.
[8] D. Petermann, G. Wichern, A. Subramanian, Z. Wang, and J. Roux, “Tackling the cocktail fork problem for separation and transcription of real-world soundtracks,” IEEE/ACM Transactions on Audio, Speech, and Language Processing, vol. 31, pp. 2592-2605, 2023.
[9] Y. Luo and J. Yu, “Music source separation with band-split RNN,” IEEE/ACM Transactions on Audio, Speech, and Language Processing, vol. 31, pp. 1893-1901, 2023.
[10]K. Watcharasupat et al., “A generalized bandsplit neural network for cinematic audio source separation,” IEEE Open Journal of Signal Processing, vol. 5, pp. 73-81, 2024.
[11] S. Haykin, Adaptive filter theory, Prentice Hall, Upper Saddle River, NJ, 4th edition, 2002.

1. A system for deriving, from an input multi-channel audio signal, a multi-channel target signal in compressed form, the system comprising:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels; and
an output unit to output the multi-channel target signal in compressed form as the single-channel target signal and the array of multi-channel projection coefficients.

2. The system of claim 1, wherein the multi-channel projection coefficients estimation block is configured to, in at least one step:
derive a first array of estimates of the projection coefficients from a version of the projection coefficients of the preceding step;
derive an array of errors between the input multi-channel audio signal, or a magnitude or another norm of it, and the estimates of the first array of estimates, or a magnitude or another norm of it;
update the first array of estimates of the projection coefficients with an array of corrections, to thereby derive a second, updated array of estimates of the projection coefficients, so that the second, updated array of the estimates constitute the array of multi-channel projection coefficients, or a predecessor of the array of multi-channel projection coefficients.

3. The system of claim 2, wherein the multi-channel projection coefficients estimation block is configured to, in the at least one step:
derive the array of errors between the input multi-channel audio signal, taken in magnitude or another norm, and the estimates of the first array of estimates, taken in magnitude or another norm.

4. The system of claim 2, wherein the multi-channel projection coefficients estimation block is configured to derive the array of corrections by scaling the array of errors by Kalman gain(s), or other coefficient(s) comparatively large for comparatively large posterior variance, comparatively small for comparatively small posterior variance, comparatively large for comparatively small observation noise variance, and comparatively small for comparatively large variance.

5. The system of claim 2, wherein the multi-channel projection coefficients estimation block is configured to average the projection coefficients of the second, updated array of estimates along the frequencies, to thereby derive the array of multi-channel projection coefficients, or a predecessor version thereof, common to all the frequencies.

6. The system of claim 2, wherein the multi-channel projection coefficients estimation block is configured to normalize the projection coefficients of the second, updated array of estimates, or an averaged or otherways processed version thereof.

7. The system of claim 2, wherein the multi-channel projection coefficients estimation block is configured to derive the first array of estimates by scaling the array of multi-channel projection coefficients of the preceding step by a constant parameter larger than 0 and smaller than 1.

8. The system of claim 7, wherein the first array of estimates is common for all the frequencies.

9. The system of claim 1, wherein the multi-channel projection coefficients estimation block is configured to derive the Kalman gain(s), or the other coefficient(s), as ratio(s) between:
a product between the density variance and the magnitude, or another norm, of the single-channel target signal at the ratio's numerator; and
a sum between the observation noise variance and a product between the energy of the single-channel target signal and the density variance at the ratio's denominator.

10. The system of claim 1, further comprising a target signal selector configured to channel-wise select the channels in which the target signal is present, thereby discarding the non-selected channels, the non-selected channels bypassing the single-channel separation block and the multi-channel projection coefficients estimation block.

11. The system of claim 1, further configured to convert the single channel downmix signal from the time domain to a time-frequency domain.

12. The system of claim 1, wherein the single-channel separation block is realized by a neural network.

13. The system of claim 1, wherein the single-channel separation block is configured to perform a deterministic separation.

14. The system of claim 1, wherein the target signal is a voice component.

15. The system of claim 1, configured to output the multi-channel target signal in compressed form as a foreground object described by the array of multi-channel projection coefficients and the single-channel target signal, and a multi-channel background object as the difference between the input multi-channel audio signal and a decompressed version of the multi-channel target signal.

16. The system of claim 15, configured to derive the decompressed version of the multi-channel target signal by scaling the single-channel target signal by the array of multi-channel projection coefficients.

17. The system of claim 1, wherein the input multi-channel audio signal is in a non-object-based format.

18. The system of claim 1, configured to transmit the multi-channel target signal in compressed form.

19. The system of claim 1, wherein the downmix block is configured to downmix the input multi-channel audio signal by adding with each other the values of the input multi-channel audio signal.

20. A system for deriving, from an input multi-channel audio signal, a multi-channel target signal in compressed form, the system comprising:
a downmix block, to downmix the input multi-channel audio signal onto one single-channel downmix signal;
a single-channel separation block, to perform a single-channel separation of the single-channel downmix channel, to derive a single-channel target signal from the single-channel audio signal,
a multi-channel projection coefficients estimation block, to derive an array of multi-channel projection coefficients capable of projecting the single-channel target signal onto multiple channels, and
an output unit to output the multi-channel target signal in compressed form as the single-channel target signal and the array of multi-channel projection coefficients,
wherein the multi-channel projection coefficients estimation block is configured to, in at least one step:
retrieve the array of multi-channel projection coefficients by minimizing, for each channel, a channel-specific cost function which is an expectation of a difference, or a quadratic version of the difference or another norm of the difference, between the channel in the input multi-channel audio signal, taken in magnitude or another norm, and a corresponding estimate of the channel of the multi-channel target signal, taken in magnitude or another norm, the estimate of the channel of the multi-channel target signal taken in magnitude or another norm being derived by scaling the single-channel target signal, taken in magnitude or another norm, by a candidate projection coefficient, so that the array of candidate projection coefficients which minimizes the cost functions is chosen as the array of multi-channel projection coefficients.

21. The system of claim 20, wherein the projection coefficients estimation block is configured to, in the at least one step:
derive a first array of estimates of the projection coefficients from a version of the projection coefficients of the preceding step;
derive an array of errors between the input multi-channel audio signal, taken in magnitude or another norm, and the estimates of the first array of estimates, taken in magnitude or another norm;
update the first array of estimates of the projection coefficients with an array of corrections, to thereby derive a second, updated array of estimates of the projection coefficients, so that the second, updated array of the estimates constitute the array of multi-channel projection coefficients, or a predecessor of the array of multi-channel projection coefficients,
wherein the array of corrections is derived by scaling the array of errors by Kalman coefficient(s), or other coefficient(s) comparatively large for comparatively large posterior variance, comparatively small for comparatively small posterior variance, comparatively large for comparatively small observation noise variance, and comparatively small for comparatively large variance.

22. A method for deriving, from an input multi-channel audio signal, a multi-channel target signal in compressed form, the method comprising:
downmixing the input multi-channel audio signal onto one single-channel downmix signal;
performing a single-channel separation of the single-channel downmix channel, to derive a single-channel target signal from the single-channel audio signal,
deriving an array of multi-channel projection coefficients projecting the single-channel target signal onto multiple channels; and
outputting the multi-channel target signal in compressed form as the single-channel target signal and the array of multi-channel projection coefficients.

23. A non-transitory digital storage medium having a computer program stored thereon to perform the method for deriving, from an input multi-channel audio signal, a multi-channel target signal in compressed form, the method comprising:
downmixing the input multi-channel audio signal onto one single-channel downmix signal;
performing a single-channel separation of the single-channel downmix channel, to derive a single-channel target signal from the single-channel audio signal,
deriving an array of multi-channel projection coefficients projecting the single-channel target signal onto multiple channels; and
outputting the multi-channel target signal in compressed form as the single-channel target signal and the array of multi-channel projection coefficients,
when said computer program is run by a computer.
